(19) United States
(12) Patent Application Publication
(10) Pub. No.: US 2025/0331694 A1
(43) Pub. Date: Oct. 30, 2025

(54) MULTIPURPOSE SPIN-ACTION CLEANING DEVICE

(71) Applicant: Edward Robinson, Hollywood, FL (US)

(72) Inventor: Edward Robinson, Hollywood, FL (US)

(21) Appl. No.: 19/049,114

(22) Filed: Feb. 10, 2025

Related U.S. Application Data
(60) Provisional application No. 63/637,979, filed on Apr. 24, 2024.

(51) Int. Cl. A47L 11/40; A47L 11/26; B60S 3/00

(52) U.S. Cl. CPC A47L 11/4069; A47L 11/26; A47L 11/4041; A47L 11/4088; B60S 3/00

(57) ABSTRACT

The present invention is a spin-action cleaning device designed to efficiently clean various surfaces by utilizing pressurized water to drive mechanical cleaning heads. The device comprises a generally T-shaped body with a longitudinal member and a lateral member, the lateral member is a rotatable bladed shaft with microfiber cleaning heads mounted at the outer ends thereof. The cleaning heads rotate along the central axis of the shaft and are driven by water directed from a pressurized sprinkler or connector inlet positioned at an angle for optimal flow. The device includes a pair of reducers, each reducer includes ball bearings integrated into the smaller end thereof to reduce rotational friction. A liquid dispenser is attached to the longitudinal member, enabling the release of cleaning solutions through the microfiber heads during operation.

### CROSS-REFERENCE TO RELATED APPLICATION

The present application claims priority to, and the benefit of, U.S. Provisional Application No. 63/637,979 which was filed on Apr. 24, 2024 and is incorporated herein by reference in its entirety.

### FIELD OF THE INVENTION

The present invention generally relates to the field of cleaning devices and tools for household, automotive, and general-purpose cleaning. More specifically, the present invention relates to a spin-action cleaning device that utilizes pressurized water to drive rotatable microfiber cleaning heads mounted on a bladed shaft. The device features a generally T-shaped body with a longitudinal member, a lateral bladed shaft, and a liquid dispenser for dispensing cleaning solutions during operation. The spin-action cleaning device addresses the specific needs of users by providing an energy-free, efficient, and cost-effective cleaning solution for a wide range of surfaces, including delicate finishes, while ensuring ease of use and portability. Accordingly, the present disclosure makes specific reference thereto. Nonetheless, it is to be appreciated that aspects of the present invention are also equally applicable to other like applications, devices, and methods of manufacture.

### BACKGROUND

By way of background, cleaning surfaces such as homes, garages, vehicles, and other objects often requires specialized equipment, particularly for removing dirt, grime, and stains. Pressure washers are commonly used for such tasks; however, they have several drawbacks. The cost of purchasing or renting a pressure washer can be a deterrent for many users. Moreover, operating a pressure washer requires training, as improper use may not only yield poor results but also cause fatigue due to the physical effort involved in handling high-pressure water streams over extended periods.

Additionally, the powerful jets from pressure washers can sometimes damage surfaces or leave unsightly “swirl” marks, detracting from the aesthetic appeal of the cleaned area. Such marks are particularly problematic on delicate surfaces such as car exteriors, wooden decks, or decorative finishes, where precision cleaning is essential to maintain integrity and visual quality.

To address the above challenges, alternative cleaning tools have been developed, but many fail to balance efficiency, case of use, and affordability. Manual scrubbing tools are labor-intensive and often ineffective against ingrained dirt, while electrically powered cleaning devices introduce the need for power sources and increase operational complexity. Individuals desire an improved cleaning device which overcomes the limitations of existing devices by providing an efficient, water-powered cleaning solution that eliminates the need for electricity and minimizes user fatigue.

Therefore, there exists a long-felt need in the art for a cleaning device that provides an efficient and cost-effective solution for cleaning surfaces such as homes, garages, and vehicles. There is also a long-felt need in the art for a device that eliminates the high cost and operational complexity associated with pressure washers. Additionally, there is a long-felt need in the art for a cleaning device that minimizes fatigue and is easy to use without requiring specialized skills or training. Moreover, there is a long-felt need in the art for a cleaning tool that can clean delicate surfaces without causing damage or leaving unsightly marks. Furthermore, there is a long-felt need in the art for a cleaning device that combines mechanical cleaning action with cleaning solutions to enhance cleaning efficiency. Finally, there is a long-felt need in the art for a water-driven cleaning device that is portable, reliable, and does not require an external power source.

The subject matter disclosed and claimed herein, in one embodiment thereof, comprises a spin-action cleaning device designed to provide efficient and versatile cleaning using water pressure. The device features a generally T-shaped body with a longitudinal member and a lateral member. The lateral member houses a bladed shaft that functions as the central axis for a pair of microfiber cleaning heads mounted on the outer ends thereof. The microfiber cleaning heads rotate when the bladed shaft is driven by pressurized water delivered through a sprinkler or connector inlet positioned at an angle. The device also includes a liquid dispenser for dispensing cleaning solutions directly through the cleaning heads. Additionally, the main body includes a pair of reducers housing the bladed shaft, equipped with ball bearings to reduce rotational friction of the shaft.

In this manner, the spin-action cleaning device of the present invention addresses all of the foregoing needs and provides a novel solution for efficient and cost-effective cleaning. The device eliminates the need for electricity by using pressurized water to drive the cleaning heads, reducing operating costs and complexity. The microfiber cleaning heads are gentle yet effective, preventing damage to delicate surfaces while providing powerful scrubbing action. The inclusion of a liquid dispenser ensures a seamless combination of mechanical action and cleaning agents, making the device suitable for various cleaning applications.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spin-action cleaning device for cleaning surfaces. The device comprises a generally T-shaped body including a longitudinal member and a bladed shaft, a pair of microfiber cleaning heads rotatably mounted at opposite ends of the bladed shaft, a pair of reducers, each reducer has a larger end and an opposite (i.e., opposing) smaller end, wherein the larger ends of the reducers are integrated to form a housing for the bladed shaft, and the smaller ends are configured to provide mounting points for the microfiber cleaning heads, a pressurized sprinkler or connector inlet is connected to the longitudinal member and positioned at an angle relative to the bladed shaft to direct pressurized water onto the blades of the shaft to induce rotation, and a plurality of ball bearings are disposed within the smaller ends of the reducers to reduce rotational friction of the bladed shaft.

In yet another embodiment, a spin-action cleaning device for use with a pressurized water source is disclosed. The device includes a longitudinal member having a distal end and a proximal end configured to connect to the pressurized water source, a lateral member is secured at the distal end of the longitudinal member, the lateral member includes a bladed shaft configured to rotate about a central axis in response to pressurized water, a pair of microfiber cleaning heads attached to outer ends of the bladed shaft, and a pair of reducers form a housing for the bladed shaft, each reducer has a larger end and a smaller end, wherein the smaller ends include ball bearings to reduce friction during rotation.

In another embodiment, a method for cleaning a surface using a spin-action cleaning device is disclosed. The method includes the steps of connecting a pressurized water source to a pressurized sprinkler or connector inlet of the cleaning device, activating the water source to channel pressurized water through the sprinkler or connector inlet to strike the blades of the bladed shaft, inducing rotation of the bladed shaft and microfiber cleaning heads attached to the outer ends of the shaft, dispensing a cleaning solution from a liquid dispenser through the microfiber cleaning heads during operation, and placing the microfiber cleaning heads in contact with a surface to clean the surface through the combined action of rotation and cleaning solution application.

In still another embodiment, the pressurized sprinkler or connector inlet includes a ¼-inch sprinkler positioned at an angle from about 30 degrees to 60 degrees relative to the longitudinal member to optimize water flow and rotational efficiency of the bladed shaft.

In still another aspect, the microfiber cleaning heads are detachable from the bladed shaft to enable for replacement or cleaning.

In yet another aspect, the liquid dispenser further comprises a removable lid for refilling with liquid cleaning solutions.

In another aspect, the reducers are constructed from polyvinyl chloride (PVC) and include adhesive-secured ball bearings for added stability during operation of the device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of spin action cleaning device of the present invention in accordance with the disclosed structure;

FIG. 2 illustrates an isolated view of a pair of reducers used in the cleaning device of the present invention in accordance with the disclosed structure;

FIG. 3 illustrates an enlarged view of the connection of the shaft with the cleaning heads in accordance with the disclosed structure;

FIG. 4 illustrates an internal view of the reducers used in the cleaning device of the present invention for enclosing and supporting the bladed shaft in accordance with one embodiment of the present invention;

FIG. 5 illustrates an enlarged view of the trigger along with the sprinkler in accordance with the disclosed structure of the cleaning device of the present invention; and

FIG. 6 illustrates a perspective view of the cleaning device being used for cleaning a vehicle in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cleaning device that provides an efficient and cost-effective solution for cleaning surfaces such as homes, garages, and vehicles. There is also a long-felt need in the art for a device that eliminates the high cost and operational complexity associated with pressure washers. Additionally, there is a long-felt need in the art for a cleaning device that minimizes fatigue and is easy to use without requiring specialized skills or training. Moreover, there is a long-felt need in the art for a cleaning tool that can clean delicate surfaces without causing damage or leaving unsightly marks. Furthermore, there is a long-felt need in the art for a cleaning device that combines mechanical cleaning action with cleaning solutions to enhance cleaning efficiency. Finally, there is a long-felt need in the art for a water-driven cleaning device that is portable, reliable, and does not require an external power source.

The present invention, in one exemplary embodiment, is a spin-action cleaning device for use with a pressurized water source. The device includes a longitudinal member having a distal end and a proximal end configured to connect to the pressurized water source, a lateral member is secured at the distal end of the longitudinal member, the lateral member includes a bladed shaft configured to rotate about a central axis in response to pressurized water, a pair of microfiber cleaning heads attached to outer ends of the bladed shaft, and a pair of reducers form a housing for the bladed shaft, each reducer has a larger end and a smaller end, wherein the smaller ends include ball bearings to reduce friction during rotation.

Reference will now be made in detail to the present preferred embodiments of the invention, examples of which are illustrated in the accompanying drawings. Wherever possible, the same reference numerals are used in the drawings and the description to refer to the same or like parts.

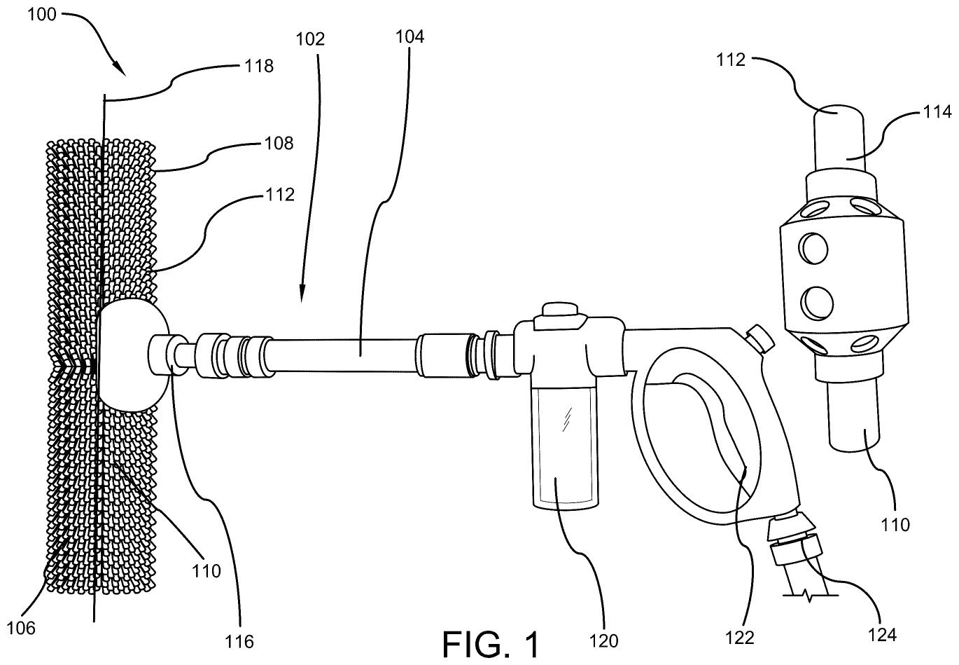

Referring initially to the drawings, FIG. 1 illustrates a perspective view of spin action cleaning device of the present invention in accordance with the disclosed structure. The spin action cleaning device 100 of the present invention is designed as an improved cleaning device for cleaning home, garage, car, or other items. The cleaning device 100 is adapted to use water pressure to drive mechanical cleaning heads for providing efficient cleaning. More specifically, the cleaning device 100 includes a generally T-shaped body 102 having a longitudinal member 104 and a pair of microfiber cleaning heads 106, 108 disposed on opposite ends 110, 112 of a lateral member 114 which is disposed at the distal end 116 of the longitudinal member 104. The cleaning heads 106, 108 are identical and are configured to rotate along the lateral member 114 as the central axis 118 for rotation. The lateral member 114 is preferably a bladed shaft as discussed later in the disclosure.

The cleaning heads 106, 108 provide an effective scrubbing action during cleaning and can be used for cleaning various types of surfaces. A liquid dispenser 120 is removably attached to the device 100 and preferably to the longitudinal member 104. The liquid dispenser 120 is configured to dispense liquid soap or water directly through the cleaning heads 106, 108. The liquid solution enhances cleaning by combining mechanical scrubbing with cleaning agents.

The device 100 includes a trigger 122 for creating a supply of water to the cleaning heads 106, 108. The trigger 122 is operatively connected to a standard water hose connector 124. The hose connector 124 is preferably a ¼-inch sprinkler and is positioned at an angle from about 30 degrees to about 60 degrees relative to the longitudinal member 104 to direct water effectively to the cleaning heads 106, 108. In another embodiment, the hose connector 124 is positioned at an angle from about 40 degrees to about 50 degrees relative to the longitudinal member 104 to direct water effectively to the cleaning heads 106, 108. Any conventional hose can be removably connected to the hose connector 124 for a supply of water without using any electrical components in the device 100. The sprinkler or connector creates a pressurized water inlet for the device 100.

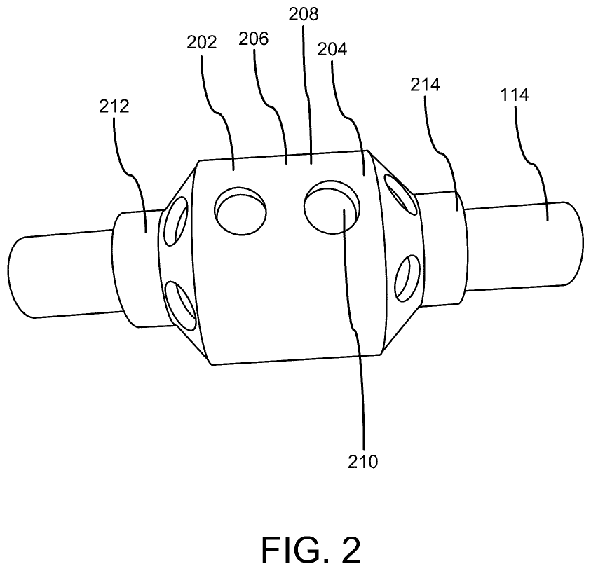

FIG. 2 illustrates an isolated view of a pair of reducers used in the cleaning device of the present invention in accordance with the disclosed structure. The device 100 uses a pair of reducers 202, 204 wherein each reducer is preferably made of polyvinyl chloride (PVC). The two reducers 202, 204 are integrated to each other at the bigger ends 206, 208 thereof respectively. The reducers 202, 204 have a plurality of relief openings 210 disposed therein for managing flow of water directed through the hose connector 124 (shown in FIG. 1).

Each reducer has a corresponding smaller end opposite (i.e., opposing) to the bigger end thereof. As illustrated, the first reducer 202 has the smaller end 212 opposite to the bigger end 206. Similarly, the second reducer 204 has the smaller end 214 opposite to the bigger end 208. The smaller ends 212, 214 are adapted to function as mounting points for the cleaning heads 106, 108 respectively. The lateral bladed shaft 114 preferably passes through the reducers 202, 204 and the outer ends of the shaft extend beyond the reducers 202, 204 to secure the cleaning heads 106, 108 thereto.

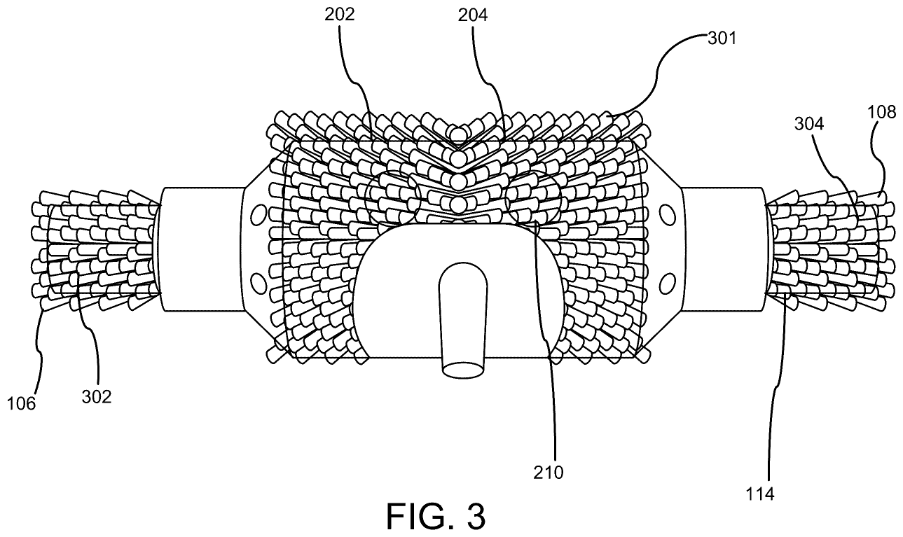

FIG. 3 illustrates an enlarged view of the connection of the shaft with the cleaning heads in accordance with the disclosed structure. The first cleaning head 106 is integrated to the first outer end 302 of the bladed shaft 114 and the second cleaning head 108 is integrated to the second outer end 304 of the bladed shaft 114. The reducers 202, 204 provide a secure housing for the bladed shaft 114, thereby enabling rotational movement of the bladed shaft 114 for rotating the cleaning heads 106, 108 to clean a surface.

It should be noted that the reducers 202, 204 are integrated to the longitudinal member 104 and do not rotate, while enabling the enclosed bladed shaft 114 to rotate wherein the rotational speed of the shaft 114 and the cleaning heads 106, 108 depend on speed and/or pressure of the water from the hose connector 124. The reducers 202, 204 can also be covered by a microfiber cover 301 for preventing direct contact between the reducers and a cleaning surface.

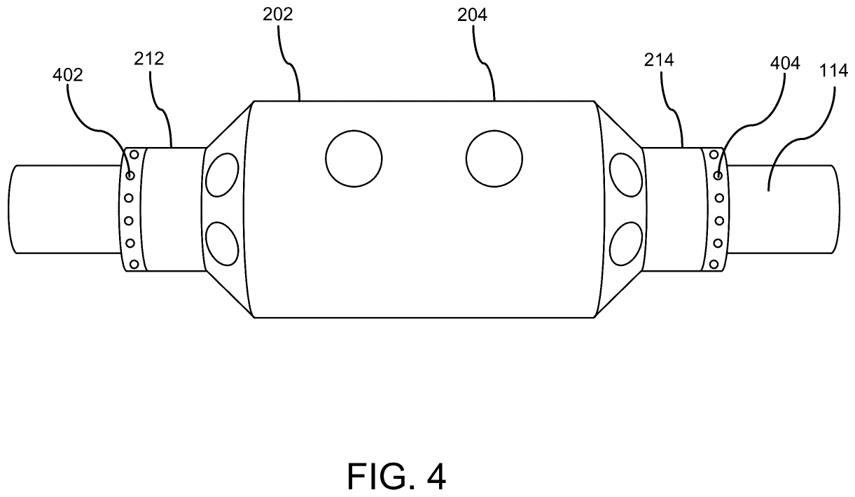

FIG. 4 illustrates an internal view of the reducers used in the cleaning device of the present invention for enclosing and supporting the bladed shaft in accordance with one embodiment of the present invention. The smaller ends 212, 214 of the reducers 202, 204 have a plurality of ball bearings 402, 404 respectively disposed therein. The ball bearings 402, 404 are configured to reduce rotational friction for the shaft 114 for smooth and uniform movement of the cleaning heads 106, 108. The ball bearings 402, 404 can be integrated inside the smaller ends 212, 214 or can be secured with adhesive or glue for secure positioning inside the reducers 202, 204.

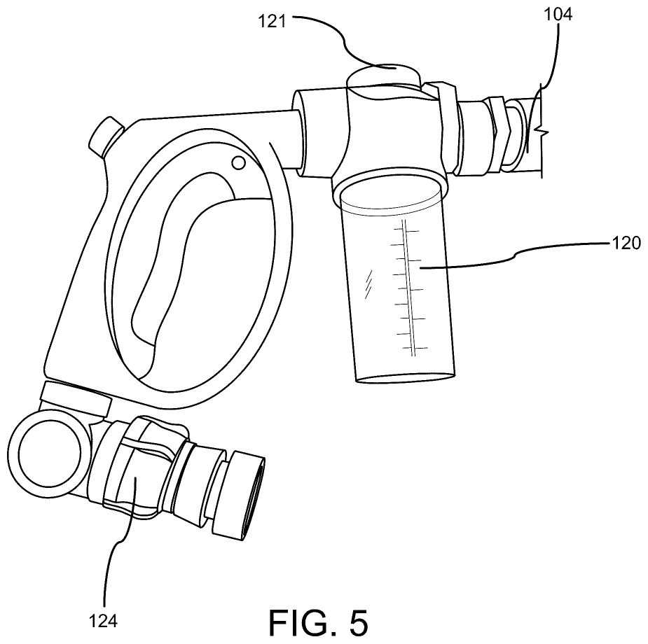

FIG. 5 illustrates an enlarged view of the trigger along with the sprinkler in accordance with the disclosed structure of the cleaning device of the present invention. In the preferred embodiment, the hose connector 124 is positioned at an angle from 30 degrees to 60 degrees relative to the longitudinal shaft 104, however, can be pivoted relative to the longitudinal shaft 104 for accommodating different hose positions for water supply. Further, the liquid dispenser 120 has a removable lid 121 which can be used for refilling the liquid dispenser 120 with a cleaning solution.

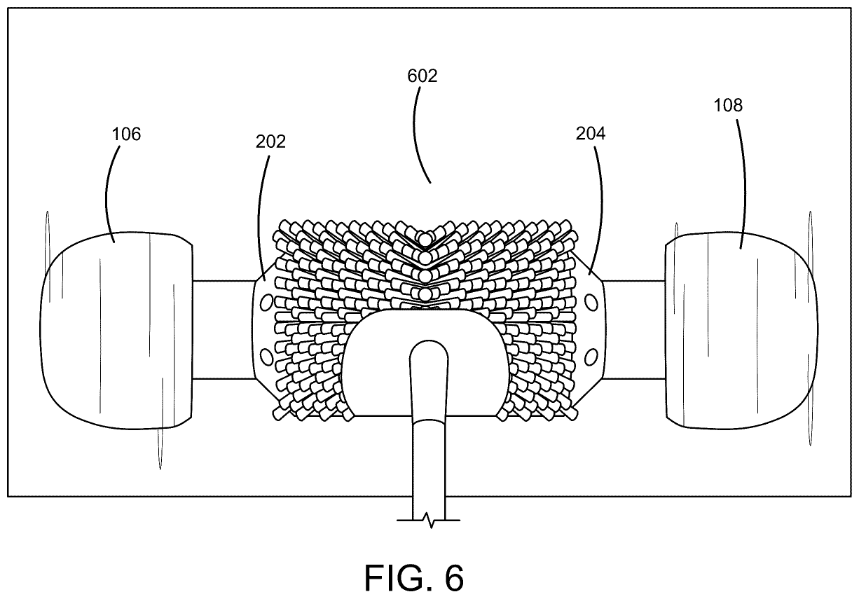

FIG. 6 illustrates a perspective view of the cleaning device being used for cleaning a vehicle in accordance with one embodiment of the present invention. For using the generally T-shaped rotational cleaning apparatus 100, the cleaning heads 106, 108 are placed on the vehicle 602 or any other object to be cleaned using the device 100. Then, the trigger 122 is pressed, enabling the water to pass through the reducers 202, 204 and the bladed shaft 114. The bladed shaft 114 rotates to rotate the cleaning heads 106, 108 to provide an effective cleaning.

It should be noted that when the device 100 is connected to a water source, the sprinkler or connector inlet 124 channels pressurized water at an angle and when the water strikes the bladed shaft 114, the shaft 114 and the cleaning heads 106, 108 rotate. The liquid soap dispenser 120 can release soap through the cleaning heads 106, 108, combining with water for an enhanced cleaning process. Advantageously, no external power supply is required for operating the device 100 and the device 100 is suitable for cleaning various surfaces like floors, windows, or vehicles.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “T-shaped rotational cleaning apparatus”, “spin cleaning device”, “spin-action cleaning device” and “device” are interchangeable and refer to the spin-action cleaning device 100 of the present invention.

Notwithstanding the forgoing, the spin-action cleaning device 100 of the present invention can be of any suitable size and configuration as is known in the art without affecting the overall concept of the invention, provided that it accomplishes the above stated objectives. One of ordinary skill in the art will appreciate that the spin-action cleaning device 100 as shown in the FIGS. are for illustrative purposes only, and that many other sizes and shapes of the spin-action cleaning device 100 are well within the scope of the present disclosure. Although the dimensions of the spin-action cleaning device 100 are important design parameters for user convenience, the spin-action cleaning device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rotatable cleaning device comprising:
a cleaning body;
a longitudinal member;
a lateral member;
a pair of cleaning heads;
a liquid dispenser; and
a hose connector;
wherein said pair of cleaning heads are microfiber cleaning heads;
wherein said lateral member disposed at a distal end of said longitudinal member;
wherein said pair of cleaning heads disposed on opposing ends of said lateral member;
wherein said lateral member having a central axis for rotating said pair of cleaning heads therearound;
wherein said lateral member having a bladed shaft;
wherein said bladed shaft extending through said lateral member; and
further wherein one of said pair of cleaning heads connected to one end of said bladed shaft and another of said pair of cleaning heads connected to an opposing end of said bladed shaft.

2. The rotatable cleaning device of claim 1, wherein said lateral member having a pair of opposing reducers, and further wherein said bladed shaft rotatable within said pair of opposing reducers.

3. The rotatable cleaning device of claim 1, wherein said liquid dispenser in fluid communication with said longitudinal member, and further wherein said liquid dispenser selectively attachable to said longitudinal member.

4. The rotatable cleaning device of claim 3, wherein said liquid dispenser dispenses liquid soap through said longitudinal member and said lateral member to said pair of cleaning heads.

5. The rotatable cleaning device of claim 4, wherein said hose connector connectable to a water hose including a trigger for actuating a water supply through said longitudinal member and said lateral member to said pair of cleaning heads.

6. The rotatable cleaning device of claim 5, wherein said hose connector is a ¼-inch sprinkler connector.

7. The rotatable cleaning device of claim 6, wherein said hose connector positioned at an angle from 40 degrees to 50 degrees relative to said longitudinal member.

8. The rotatable cleaning device of claim 2, wherein said pair of opposing reducers having a plurality of relief openings disposed therein for water to pass therethrough.

9. The rotatable cleaning device of claim 8, wherein a first reducer of said pair of opposing reducers having a first end diameter and a second end diameter, and further wherein said second end diameter of said first reducer smaller than said first end diameter.

10. The rotatable cleaning device of claim 9, wherein a second reducer of said pair of opposing reducers having a first end diameter and a second end diameter, and further wherein said second end diameter of said second reducer smaller than said first end diameter.

11. The rotatable cleaning device of claim 10, further wherein a rotational speed of said bladed shaft dependent upon a pressure of water passing over said bladed shaft.

12. A rotatable cleaning device comprising:
a cleaning body;
a longitudinal member;
a lateral member;
a pair of cleaning heads;
a liquid dispenser; and
a hose connector;
wherein said lateral member disposed at a distal end of said longitudinal member;
wherein said pair of cleaning heads disposed on opposing ends of said lateral member;
wherein said lateral member having a central axis for rotating said pair of cleaning heads therearound;
wherein said lateral member having a bladed shaft;
wherein said bladed shaft extending through said lateral member; and
wherein one of said pair of cleaning heads connected to one end of said bladed shaft and another of said pair of cleaning heads connected to an opposing end of said bladed shaft;
wherein said lateral member having a pair of opposing reducers;
wherein said bladed shaft rotatable within said pair of opposing reducers; and
further wherein said pair of opposing reducers having a plurality of relief openings disposed therein for water to pass therethrough.

13. The rotatable cleaning device of claim 12, wherein a first reducer of said pair of opposing reducers having a first end diameter and a second end diameter, and further wherein said second end diameter of said first reducer smaller than said first end diameter.

14. The rotatable cleaning device of claim 13, wherein said liquid dispenser in fluid communication with said longitudinal member, and further wherein said liquid dispenser dispenses liquid soap through said longitudinal member and said lateral member to said pair of cleaning heads.

15. The rotatable cleaning device of claim 14, wherein said hose connector connectable to a water hose including a trigger for actuating a water supply through said longitudinal member and said lateral member to said pair of cleaning heads.

16. The rotatable cleaning device of claim 15, wherein said hose connector positioned at an angle from 40 degrees to 50 degrees relative to said longitudinal member.

17. The rotatable cleaning device of claim 13, wherein a second reducer of said pair of opposing reducers having a first end diameter and a second end diameter, and further wherein said second end diameter of said second reducer smaller than said first end diameter.

18. The rotatable cleaning device of claim 17, wherein a rotational speed of said bladed shaft dependent upon a pressure of water passing over said bladed shaft.

19. A rotatable cleaning device comprising:
a cleaning body;
a longitudinal member;
a lateral member;
a pair of cleaning heads;
a liquid dispenser; and
a hose connector;
wherein said lateral member disposed at a distal end of said longitudinal member;
wherein said pair of cleaning heads disposed on opposing ends of said lateral member;
wherein said lateral member having a central axis for rotating said pair of cleaning heads therearound;
wherein said lateral member having a bladed shaft;
wherein said bladed shaft extending through said lateral member; and
wherein one of said pair of cleaning heads connected to one end of said bladed shaft and another of said pair of cleaning heads connected to an opposing end of said bladed shaft;
wherein said lateral member having a pair of opposing reducers;
wherein said bladed shaft rotatable within said pair of opposing reducers;
wherein said pair of opposing reducers having a plurality of relief openings disposed therein for water to pass therethrough;
wherein said hose connector positioned at an angle from 40 degrees to 50 degrees relative to said longitudinal member; and
further wherein a rotational speed of said bladed shaft dependent upon a pressure of water passing over said bladed shaft.

20. The rotatable cleaning device of claim 19, wherein a first reducer of said pair of opposing reducers having a first end diameter and a second end diameter, wherein said second end diameter of said first reducer smaller than said first end diameter, wherein a second reducer of said pair of opposing reducers having a first end diameter and a second end diameter, and further wherein said second end diameter of said second reducer smaller than said first end diameter.
